(19) United States
(12) Patent Application Publication
(10) Pub. No.: US 2004/0017513 A1
(43) Pub. Date: Jan. 29, 2004

(54) Electronic equipment, server, and presentation method of layout script text

(76) Inventor: Naomasa Takahashi, Chiba (JP)

Correspondence Address: FROMMER LAWRENCE & HAUG LLP, 745 FIFTH AVENUE, NEW YORK, NY, 10151, US

(21) Appl. No.: 10/623,934

(22) Filed: Jul. 21, 2003

(30) Foreign Application Priority Data
Jul. 22, 2002 (JP) P2002-213037

(51) Int. Cl. G09G 5/00; H04N 7/00; H04N 11/00

(52) U.S. Cl. 348/552; 345/156

(57) ABSTRACT

An electronic equipment capable of displaying input data from an external interface in a display region defined by a layout script text and of enabling a user to easily select a layout which is desired to be adopted is provided. The electronic equipment, such as a television set, takes in a layout script text from outside through, for example, a network to store it in the electronic equipment, which layout script text defines at least media information and a display region of the media information, which is input through various interfaces such as a video input terminal, broadcast reception, a reader of a detachably mountable storage medium. The user selects an arbitrary layout script text among the stored layout script texts. Then, the electronic equipment reproduces media information in accordance with the selected layout script text to display the media information.

### CROSS REFERENCE TO RELATED APPLICATION

This application claims priority from Japanese Priority Document No. 2002-213037, filed on Jul. 22, 2002 with the Japanese Patent Office, which document is hereby incorporated by reference.

### BACKGROUND OF THE INVENTION

1. Field of the Invention

The present invention relates to an electronic equipment equipped with the function of reproducing various media elements such as a moving picture, a still picture, a text and the like in accordance with a script text defining at least a layout of the media elements on a display screen for them. The present invention further relates to a server for presenting a script text to the electronic equipment, and a method for distributing a script text from a server to electronic equipment.

2. Description of the Related Art

As a system for totally treating different media elements such as a moving picture, a still picture, a text, a voice and the like, for example, the Multimedia Messaging Service (MMS) exists. The MMS is based on the Synchronized Multimedia Integration Language (SMIL), which is being standardized as an application language of the extensible Markup Language (XML) by the World Wide Web Consortium (W3C). The MMS has a mechanism for integrating different media elements such as a moving picture, a still picture, a text, a voice and the like into a synchronized multimedia presentation in accordance with a script of the SMIL operating as a scenario of the integration.

The SMIL can script, for example, a layout (a position and a size) and timing of a visual media element such as a moving picture, a still picture, a text and the like, and, for example, timing of a visual media element. The SMIL can produce the above-mentioned synchronized multimedia presentation with a high degree of freedom.

Incidentally, the script specifying a media element by means of the SMIL is basically limited to a Uniform Resource Identifier (URI) including a Uniform Resource Locator (URL) and a Uniform Resource Name (URN). To be more specific, the URI is limited to one existing as a file or one capable of being specified by a URL in the Web.

Further, in recent years, various kinds of external interfaces mounted in electronic equipment such as a Personal Computer (PC), a Personal Digital (data) Assistant (PDA), Windows (registered Trademark) CE equipment, a mobile telephone, a built-in disk type television set and the like have become variously diversified to ones such as the inputs of an imaging system of a digital still camera, a digital video camera and the like, the inputs of an broadcast system of a terrestrial broadcast, a Broadcast Satellite (BS) broadcast and the like, the inputs of a game machine, and the like.

However, the layout script language such as the SMIL cannot normally specify the input data from the external interfaces.

Moreover, this fact can also be applied to the data stored in a detachably mountable external storage medium such as a Memory Stick, a Secure Digital (SD) memory card, a Compact Flash (registered Trademark), Smart Media, a Multi-Media Card (MMC) and the like.

### SUMMARY OF THE INVENTION

The present invention was made for solving the problems. It is an advantage of the present invention to provide an electronic equipment capable of displaying input data from an external interface in a display region defined by a layout script text and enabling a user to select a layout to be adopted.

Moreover, it is another advantage of the present invention to provide a server realizing a service of distributing a layout script text to an electronic equipment capable of displaying input data from the external interface in a display region defined by a layout script text, and a distribution method of the layout script text.

For obtaining the advantages, an electronic equipment according to the principal point of view of the present invention comprises a display unit including a display screen, an interface for inputting visual media information from outside, script text acquisition means for taking in a media element including the visual media information capable of being input from the interface and a script text defining at least a display layout of the media element on the display screen from outside, a script text storage unit for storing one or more script texts which is taken in by the script text acquisition means, script text selection means for selecting an arbitrary script text from one or more script texts stored in the script text storage unit, and script process means for making the media element be displayed on the display screen in accordance with the script text selected by the script text selection means.

In the present invention, a layout script text can define a display region for visual media information to be input from interfaces for inputting the visual media information from the outside such as not only the media element to be presented as a file, but also a video input terminal, broadcast reception, a reader of a detachably mountable storage medium and the like. An electronic equipment displays and reproduces the visual media element on the basis of the layout script text. The electric equipment of the invention takes in various kinds of layout script texts from the outside and stores them. Then, the electronic equipment of the invention selects an arbitrary layout script text among the stored ones. Consequently, the electronic equipment of the invention can display and reproduce various media elements including visual media information entered from the interfaces in a user's preferable layout.

In the electronic equipment of the invention, the interface may include a function of inputting visual media information different from each other through a plurality of channels, and the script text may include information for defining the interface for inputting the media element and the channels of the interface. In this case, especially as for the interface having a plurality of channels such as a terrestrial broadcast and a BS broadcast, it is possible to display the media of an arbitrary channel in a display region defined by a layout script text.

Moreover, in the electronic equipment of the invention, the script text acquisition means may select a desired script text and take in the script text from a server for presenting the script text through a network. In this case, it is possible to own a layout script text commonly among various electronic equipments connected to a network such as a Local Area Network (LAN), a Wide Area Network (WAN) and the like. Consequently, the acquisition and the exchange of a layout script text become easy. Moreover, in the electronic equipment of the invention, the script text acquisition means may select a desired script text and take in the script text from a detachably mountable storage medium recording the script text.

A server according to another aspect of the present invention comprises a script text storage unit for storing a media element including visual media information to be input into electronic equipment from the outside through an interface, and a script text defining at least a display layout of the media element on a display screen, and script text distribution means for reading a corresponding script text from the script text storage unit to distribute the script text to the electronic equipment through a network in response to a request from the electronic equipment being a client.

In this case, the layout script text can define a display region for visual media information to be input from interfaces for inputting the visual media information from the outside such as not only the media element to be presented as a file, but also a video input terminal, broadcast reception, a reader of a detachably mountable storage medium and the like. The layout script text can be distributed to the electronic equipment through the network.

The server of the invention may further comprises recognition means for recognizing a specification of the electronic equipment being a requester, and script change means for changing a content of a script text read from the script text storage unit to be optimized according to the specification of the electronic equipment recognized by the recognition means. In this case, a layout script text distribution service can be realized to the objects of various kinds of electronic equipments having different screen sizes and different mounted external interfaces.

A presentation method of a layout script text according to a further aspect of the present invention, the method comprises the steps of connecting a server to electronic equipment through a network, the server including a media element having visual media information to be input to the electronic equipment from the outside through an interface, and a script text storage unit storing a script text defining at least a display layout of the media element on a display screen, the electronic equipment including a function of making the media element be displayed on a display screen in accordance with an arbitrary script text, requesting a distribution of the arbitrary script text to the server from the electronic equipment, and reading a corresponding script text from the script text storage unit to distribute the script text to the electronic equipment through the network in response to the requesting with the server.

In this case, the layout script text can define a display region for visual media information to be input from interfaces for inputting the visual media information from the outside such as not only the media element to be presented as a file, but also a video input terminal, broadcast reception, a reader of a detachably mountable storage medium and the like. The layout script text can be distributed to the electronic equipment through the network.

Moreover, in the presentation method of a layout script text, the server may recognize a specification of the electronic equipment being a requester, and may change a content of a script text read from the script text storage unit to be optimized in accordance with the recognized specification of the electronic equipment, and further may distribute the changed script text to the electronic equipment. In this case, a layout script text distribution service can be realized to the objects of various kinds of electronic equipments having different screen sizes and different mounted external interfaces.

### BRIEF DESCRIPTION OF THE DRAWINGS

FIG. 1 is a block diagram showing the configuration of a television set of an embodiment of the present invention;

FIG. 2 is a block diagram showing the configuration of a synchronized and integrated multimedia presentation architecture in the television set of FIG. 1;

FIG. 3 is a software stack diagram of the television set of FIG. 1;

FIG. 4 is a view showing an example of a layout script text;

FIG. 5 is a view showing an example of a layout script text including a function of adjusting a contrast and the like;

FIG. 6 is a view showing an example of the configuration of a screen including a video input;

FIG. 7 is a flowchart showing a procedure of a medium reproduction process based on a layout script text including a video input;

FIG. 8 is a view showing an example of a conventional script of the SMIL;

FIG. 9 is a view showing examples of the layouts of a plurality of layout script texts;

FIG. 10 is a block diagram showing an example of the configuration of a system for distributing a layout script text from a server to request side equipment;

FIG. 11 is a view showing the state of the selection of a layout by the operation of channel selection buttons of a remote controller;

FIG. 12 is a flowchart showing a procedure for distributing a layout script text from the server to request side equipment;

FIG. 13 is a view showing an example realizing the selection of a layout realized by each of a plurality of layout script texts by the use of a layout list on a PDA; and

FIG. 14 is a flowchart showing a procedure for optimizing and distributing a layout script text according to the specifications of a request side terminal.

### DETAILED DESCRIPTION OF THE PREFERRED EMBODIMENTS

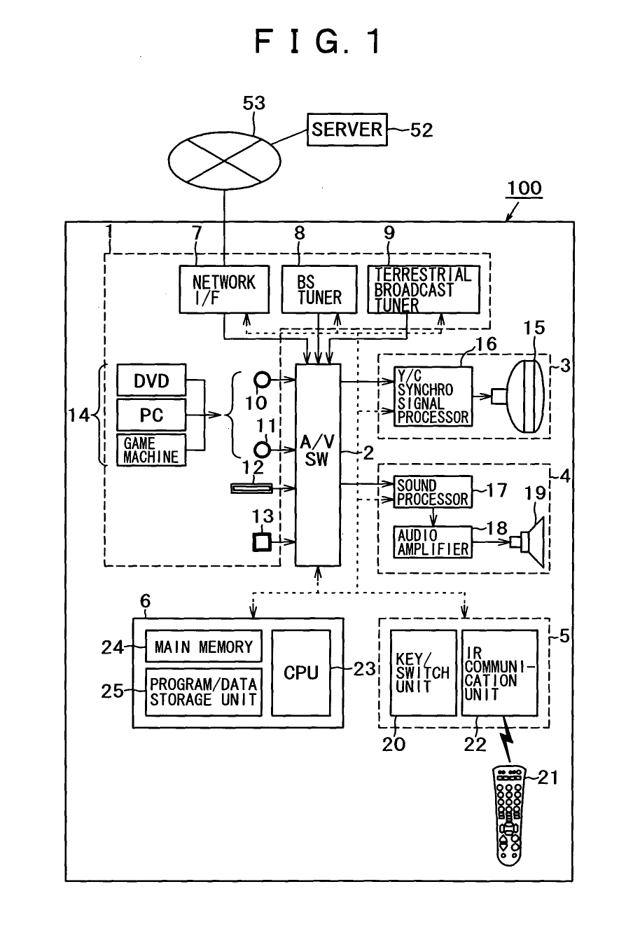

In the following, a preferred embodiment of the present invention will be described in detail on the basis of the attached drawings. FIG. 1 is a block diagram showing the configuration of a television set to which the present invention is applied.

As shown in the drawing, a television set 100 is composed of an interface 1, an audio visual switch (A/V SW) 2, a video unit 3, an audio unit 4, an operation input unit 5, and a control unit 6.

The interface 1 includes a network I/F (Network Interface) 7 as connection means with the Internet 53, a BS tuner 8 for receiving a BS broadcast, a terrestrial broadcast tuner 9 for receiving a terrestrial broadcast, a video input terminal 10, an audio input terminal 11, a memory card slot 12 for reading and writing a memory card, an i-Link (digital video (DV) terminal) 13 and the like are provided.

Through the video input terminal 10 and the audio input terminal 11, video data and audio data are taken in from external connection equipments 14 such as a Digital Versatile Disk (DVD), a Personal Computer (PC), a Game Machine and the like.

The A/V SW 2 performs the selection of inputs of video data and audio data from each equipment included in the interface 1, and the like.

The video unit 3 is composed of a display 15 such as a Cathode Ray Tube (CRT), a Liquid Crystal Display (LCD) and the like, and a Y/C synchronizing signal processor 16 for generating a video signal to be able to display on the display 15 from the video data selected by the A/V SW 2.

The audio unit 4 is composed of a sound processor 17 for processing audio data selected by the A/V SW 2, an audio amplifier 18 for amplifying the output of the sound processor 17, a speaker 19 for aurally outputting the amplified audio signal from the amplifier 18.

The operation input unit 5 is means for processing various operation entered by a user, and is composed of a key/switch unit 20 mounted on the main body of the television set and an Infra-Red ray (IR) communication unit 22 performing IR wireless communication between a remote controller 21 and the television set 100.

The control unit 6 is composed of a Central Processing Unit (CPU) 23, a main memory 24, a program/data storage unit 25 and the like. The CPU 23 executes various operation processes and controls by the use of the main memory 24 as a work-space on the basis of the programs and the data stored in the program/data storage unit 25 and the input entered from the operation input unit 5. The main memory 24 is preferably a high speed memory such as a Random Access Memory (RAM) and the like which can read and write data randomly. The program/data storage unit 25 is a nonvolatile type memory device which can only read or can read and write, and is composed of, for example, a Read Only Memory (ROM), a Flash ROM, a Disk Drive and the like.

The program/data storage unit 25 stores a layout script text, and further stores software groups for interpreting the layout script to integrate a synchronized multimedia presentation and for realizing the function of reproducing the synchronized multimedia presentation by means of the control unit 6.

The mechanism of the integration of the synchronized multimedia presentation in the case where the layout script language is the SMIL (Synchronized Multimedia Integration Language) will be described as an example.

The SMIL is the synchronized multimedia integration language the standardization of which has been promoted by the W3C (World Wide Web Consortium) by the use of the XML (sxtensible Markup Language) as a base.

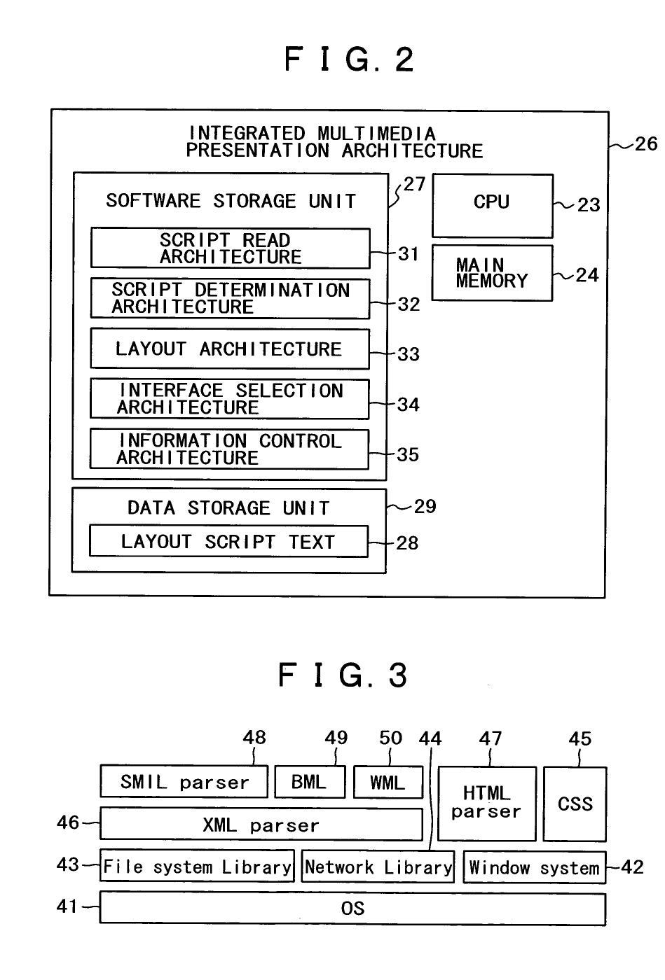

FIG. 2 shows the configuration of a synchronized and integrated multimedia presentation architecture 26 incorporated in the television set 100. The integrated multimedia presentation architecture 26 is composed of a script read architecture 31, a script determination architecture 32, a layout architecture 33, an interface selection architecture 34 and an information control architecture 35. These architectures 31 to 35 are stored in a software storage unit 27 in the program/data storage unit 25 shown in FIG. 1 as programs those are executed by the CPU 23 while reading into the main memory 24. The configuration of the programs will be described later in detail.

On the other hand, the layout script text 28 is stored in, for example, a data storage unit 29 in the program/data storage unit 25 or the like. However, the storage sites of the programs 31 to 35 and the layout script text 28 are not necessarily to be the program/data storage unit 25 in the control unit 6, and the storage sites may be, for example, a memory card mounted detachably in the memory card slot 12 and other external storage device. The storage sites may be a local external storage unit or an external storage unit on a network.

The script read architecture 31 realizes the function of reading the layout script text 28 into the main memory 24 from the data storage unit 29.

The script determination architecture 32 is a program for making the control unit 6 execute a syntax check of the layout script text 28 read into the main memory 24, a propriety check of the layout script text 28 as an XML text, a propriety check of the layout script text 28 as an SMIL text, and the like. When the layout script text 28 passes these checks, the script determination architecture 32 cuts and divides the layout script text 28 into meaningful pieces. Moreover, the script determination architecture 32 determines a display region to be set on a screen, a media element to be displayed in the display region and an external information source of the media element at every divided piece of the layout script text 28.

To be more specific, the script determination architecture 32 cuts and divides the layout script text 28 into, for example, blocks including a head element and a body element. If a layout element is allocated in a child of the head element in a divided block, the script determination architecture 32 assigns a region for allocating the media element in the body element on the screen on the basis of the layout element.

Hereupon, an URI schema defining the interpretation of the character string defining an external information source and the like is used for determining the external information source of a media element and the like. To be more specific, the script determination architecture 32 examines whether there is the script “videoinput”, which is the name of a schema, as a value of a src attribute in a video element or not. If the script “videoinput” exists, the script determination architecture 32 performs a retrieval of the URI and refers to a retrieved schema to interpret a succeeding character string (for example, “video1”) for judging which interface of the television set 100 is the external information source. Then, the script determination architecture 32 reports the result of the judgment to the interface selection architecture 34. If the script “videoinput” does not exist, the script determination architecture 32 determines that the media element is a file in the television set 100 or data on the WWW.

Moreover, the script determination architecture 32 interprets a character string succeeding “?” after the character string defining the external information source in accordance with the schema, and interprets the additional information which is entered from the interface and is related to a media element. Then, the script determination architecture 32 transfers the result of the interpretation to the information control architecture 35 and the like.

The layout architecture 33 is a program for realizing the function of executing the layout of the display region determined by the script determination architecture 32 on the display screen by means of the control unit 6.

The interface selection architecture 34 is a program for realizing the function of selecting the visual media information entered from the interface determined by the script determination architecture 32 as the media element to be displayed in the display region assigned by the layout architecture 33 by means of the control unit 6.

The information control architecture 35 is a program for realizing the function of supplying various pieces of control information to the equipment connected to the interfaces by means of the control unit 6 on the basis of the additional information determined by the script determination architecture 32. The information control architecture 35 makes the control unit 6 transmit, for example, the channel information of the BS broadcast to the BS tuner 8.

The integrated multimedia presentation architecture 26 of this embodiment is realized by, for example, stacks of software shown in FIG. 3 in the actual television set 100.

In FIG. 3, an operating system (OS) 41 is basic software for executing the supervising management of the hardware resources and the software resources that constitute the television set 100.

A window system 42 is software for managing display of windows on the display screen and the like. A file system library 43 is a library of software parts necessary for performing the file management by the use of a file system.

A network library 44 is a library of software parts necessary for performing connection to various kind of networks. A Cascading Style Sheet (CSS) 45 is a style sheet for determining the design of a text scripted with a markup language such as a Hyper Text Markup Language (HTML), the XML and the like.

An XML parser 46, an HTML parser 47, a SMIL parser 48 are severally software for judging the logical structures of an XML text, an HTML text, an SMIL text, respectively, by performing the read, the parsing, the propriety check and the like of the texts severally to generate the data which an application for reproducing the actual media information can use. That is, the XML parser 46 and the SMIL parser 48 are the software which functions as a core of the above-mentioned integrated multimedia presentation architecture 26.

A Broadcast Markup Language (BML) 49 is a markup language which is based on the XML and is used as the scripting of contents to be used for a BS digital broadcast, and is used for performing the layout of the contents on the screen, the association of a plurality of contents, and the like. Thereby, it becomes possible to use the BS digital broadcast as an external information source. A Wireless Markup Language (WML) 50 is a markup language to be used in the Wireless Application Protocol (WAP) being a communication protocol for a portable terminal such as a PDA, a mobile telephone and the like. By means of the WAP, it is possible to access from the portable terminal to the contents on the Internet.

Next, a mechanism for displaying input data from the interface 1 of the television set 100 in a region defined by a layout script in the case where the SMIL is used as the layout script language will be described in detail.

The layout script of the SMIL is mainly composed of a part defining the display region and a part defining which external information source information is displayed from in the defined display region. However, by scripting the part defining the external information source with a character string the interpretation of which is determined by the URI schema, it becomes possible to define an arbitrary external information source.

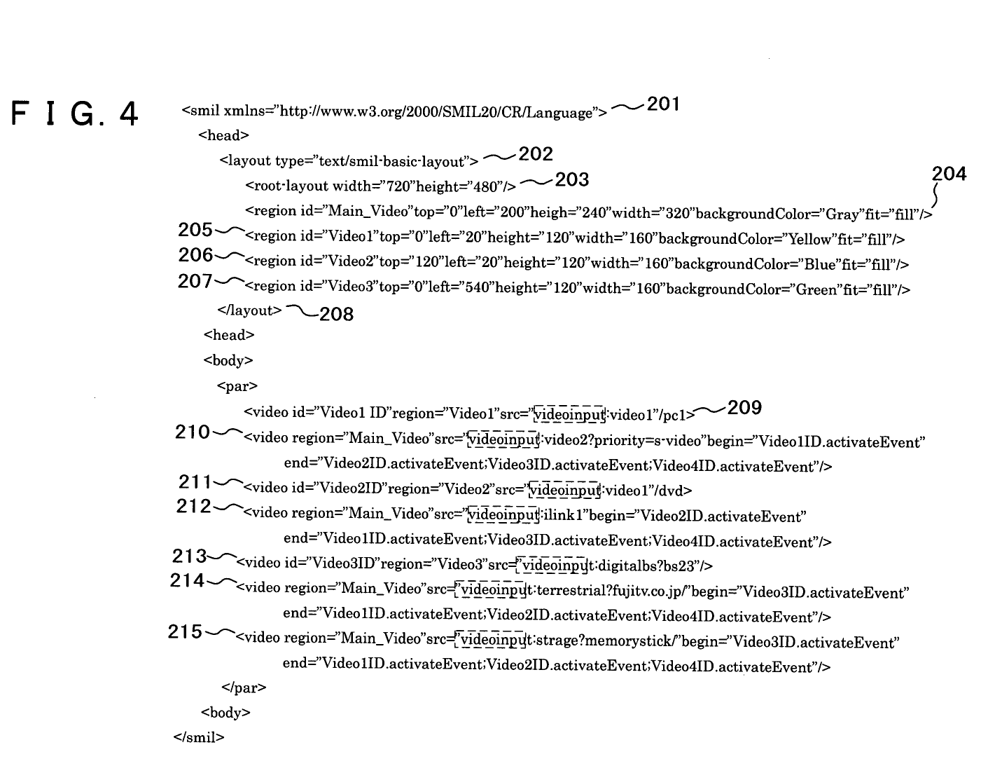

In an example of the layout script text shown in FIG. 4, the name of the schema “videoinput” is scripted in a video element 209 for defining the external information source of the information to be displayed in the region of “Video1” in dependence on the schema. The script “videoinput:video1” means that the input data from the equipment connected to the interface called as “video1” is displayed in the display region.

That is, a schema-dependent URI script has a structure in which a character of colon “:” is put after the name of a schema and a character string (scheme-specific-part) the interpretation of which depends on the schema.

Consequently, in the script of the video element 209, the script “videoinput” means that the interpretation of the character string to be scripted next is performed by referring to the schema having the name “videoinput”. If the schema is defined as one for entering the information from the equipment connected to the interface indicated by the character string to be scripted next, the interface can be specified as the external information source, and the information entered from the equipment connected to the interface can be specified as the external information to be displayed in the display region.

Moreover, in a video element 212 shown in FIG. 4, there is a script expressed as “videoinput:ilink1”, which is an input of the i-Link 13 specified as the external information source to be displayed in the display region.

Similarly, the script “videoinput:digitalbs” of a video element 213 means to specify an input of a received BS broadcast as an external information source to be displayed in the display region. The script “videoinput:terrestrial” of a video element 214 means to specify a terrestrial broadcast as an external information source to be displayed in the display region.

Moreover, the present invention is not limited to specify the kinds of the interfaces, but it is possible to specify also the kinds of concrete equipment connected to the interfaces with character strings to be interpreted in dependence on schemas.

For example, there is a script expressed as “video1”/pc1” in the video element 209, and the script indicates that the equipment connected to the interface named as “video1” is a personal computer. Similarly, a script “video1”/dvd” in a video element 211 indicates that the equipment connected to the interface named as “video1” is a DVD. If there is a script “video1”/game1”, it indicates that the equipment is the game machine 1.

Moreover, it is possible to give meanings of further detailed operations and controls to specific equipment as additional information to character strings to be interpreted in accordance with the definitions in schemas. For example, it is possible to instruct reception channels of a receiver for BS broadcasts, terrestrial broadcasts and the like. As a specific implementation method of the addition of additional information, there is a method to express the operations and the controls of equipment as queries used in URL retrieval home pages, Bulletin Board System (BBS) based home pages and the like.

In case of BBS based URLs, they can be scripted as follows.

http://bbs.arukikata.co.jp/report/europe/board/index.php?qid=26

In this case, the script “qid=26” succeeding the term “?” is a parameter indicating the thing to be transferred to a Common Gateway Interface (CGI). To be more specific, this script means to perform a request of acquiring a script located at the 26th address in a message board in a BBS based home page to a server. By using the mechanism described above, it becomes possible to transfer arbitrary information to the equipment connected to the interface specified by referring to the schema.

In the following, specific examples of the mechanism will be described. In the video element 213 of FIG. 4, a script “?BS23” exists at the position succeeding the script “videoinput:digitalbs”, and thereby it is possible to instruct a BS broadcast receiver which is interpreted in dependence on the schema to select a channel 23. Similarly, in the video element 214, there is a script “?fujitv.co.jp” after a script “videoinput:terrestrial”, and thereby it is possible to instruct a receiver for terrestrial broadcasts to select a channel (URL) to receive.

Moreover, in a video element 210, there is a script “videoinput:video2?priority=s-video”. The script means that, if there is a plurality of picture signals entered in the interface called as “video2”, an S-video input has a priority.

The description is supplemented on this point. Namely there are an S-video input having a separated luminance signal (Y signal) and a color signal (C signal) and a CV input having a composite signal of the Y signal and the C signal. Since which input of the two is entered depends on the condition of the side of equipment outputting video, there is a case where an interface for video is adapted to be able to deal with any of the video inputs of the S-video and the CV. In such a case, either one of the video inputs can be selected by the above-mentioned script “?priority=s-video”. When both the video signals are entered at the same time for example, it is possible to select one of the video inputs.

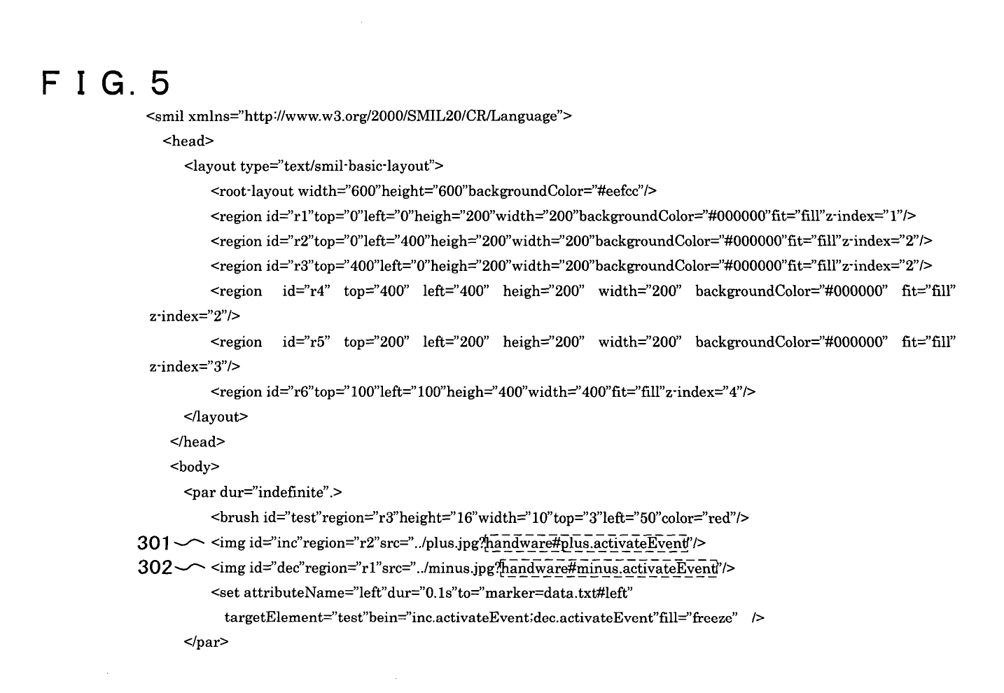

Moreover, by using the term “?”, it is possible to control the picture, the contrast and the like of a display screen. FIG. 5 shows a script example of the SMIL in this case. Incidentally, it is only an example to define the above-mentioned function to the term “?” in a schema. In place of the definition, it is possible to define any of the reserved words defined in the Request For Comments (RFC): 2396.

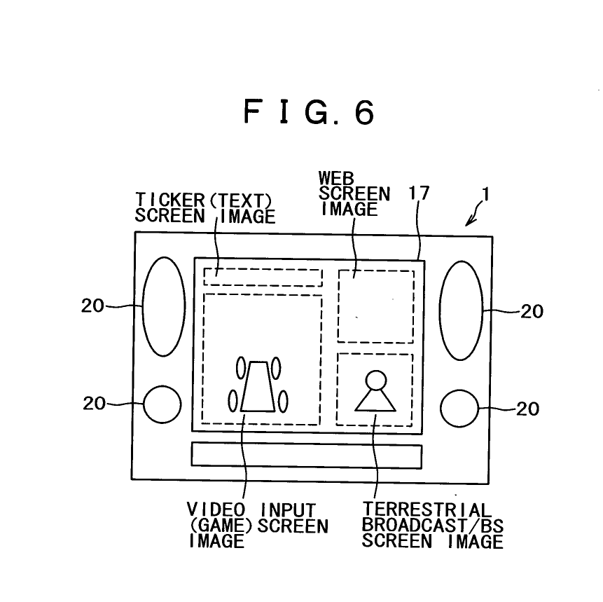

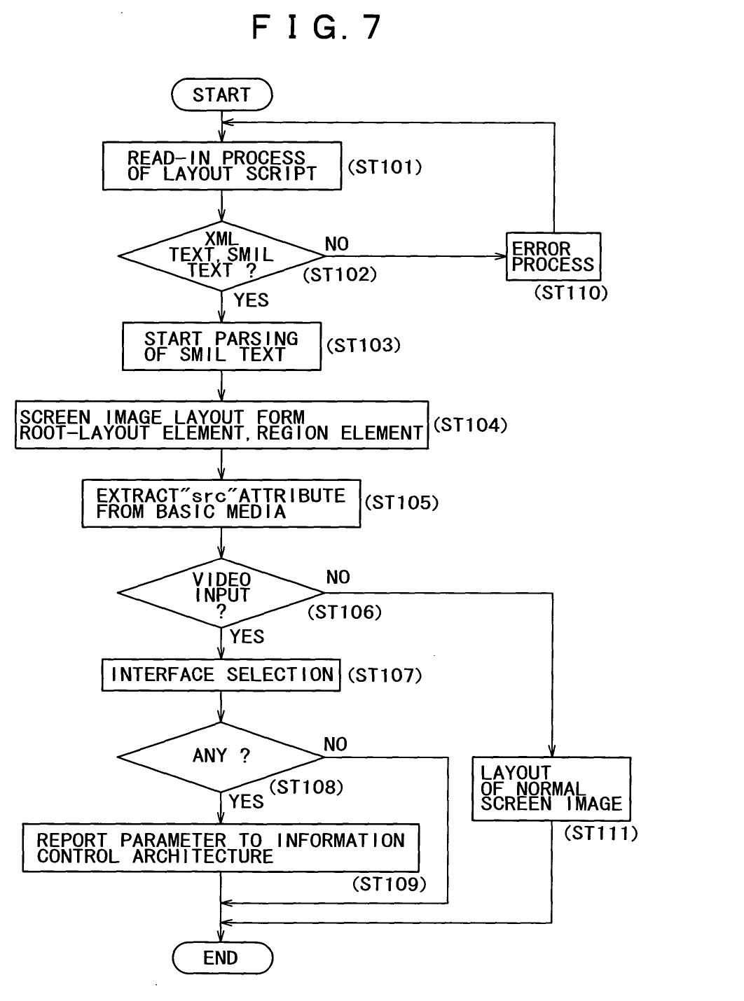

Next, the operation of the television set 100 configured as described above will be described. FIG. 6 shows an example of a screen including video inputs, and FIG. 7 is a flowchart showing an operation procedure for displaying a video input.

For example, as shown in FIG. 6, a case where information such as text information, Web information, terrestrial broadcast information, a game image and the like are displayed on the display screen 17 of the television set 100 at the same time will be considered. It is supposed that the layout script text 28 is stored in advance in the program/data storage unit 25.

As shown in FIG. 7, the script read architecture 31 reads in the layout script text 28 from the program/data storage unit 25 (Step ST101). In the case where a plurality layout script texts 28 is stored in the program/data storage unit 25, the script read architecture 31 makes the display screen 17 display a list of, for example, reduced size of layout drawings, and thereby it is possible to make a user select a desired layout in the list.

Next, the script determination architecture 32 of the control unit 6 determines whether the layout script text 28 is an XML text or not, and furthermore whether the layout script text 28 is an SMIL text or not (Step ST102). When the script determination architecture 32 determines that the layout script text 28 is neither the XML text nor the SMIL text, the script determination architecture 32 performs an error process (Step ST110), and returns the processing to Step ST101. When the script determination architecture 32 determines that the layout script text 28 is the SMIL text, the script determination architecture 32 starts the parsing of the SMIL text. At first, the script determination architecture 32 performs the cut and division of the SMIL text (Step ST103).

Next, the script determination architecture 32 divides the cut pieces into, for example, a part defining the layout of the display region and a part defining the display of information from which external information source in the display region. Then, the script determination architecture 32 determines each of the scripts. To be more specific, the script determination architecture 32 determines, for example, the contents of the root-layout element 203 and the region elements 204 to 207 in the SMIL text shown in FIG. 4, and reports the result of the determination to the layout architecture 33. When the layout architecture 33 receives the report, the layout architecture 33 assigns a display region in the display screen 17 (Step ST104).

Now, there are the scripts top=0 and left=200 in the region element 204, and the scripts declares that the upper left of the display region of “Main_Video” is located at the coordinates 0 from the upper end and 200 from the right side end. Moreover, if an element regarding time is incorporated in this case, it is possible to define the behavior related to time of each display region.

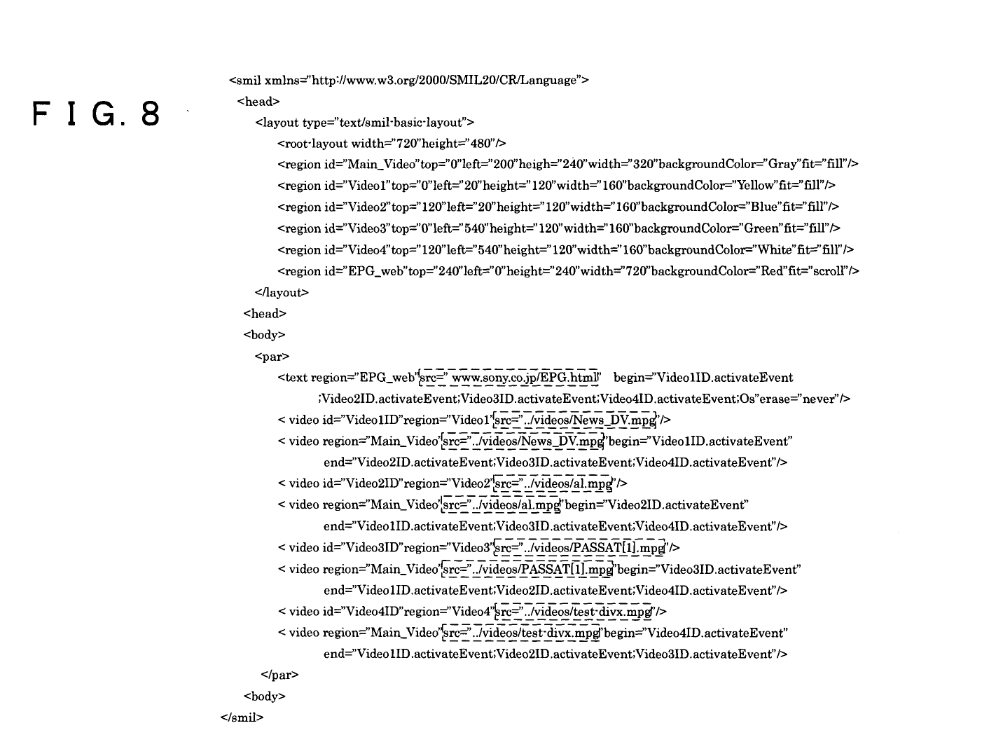

Next, the script determination architecture 32 extracts the values of src attributes from the elements 209 to 215 (Step ST105), and judges whether there is the script “videoinput”, which is the name of the URI schema, or not (Step ST106). When the script “videoinput” exists, the script determination architecture 32 interprets the character string such as “video2” and the like succeeding the script “videoinput” by referring to the schema to transfer the result of the interpretation to the interface selection architecture 34. When the interface selection architecture 34 receives the result, the interface selection architecture 34 selects a corresponding interface (Step ST107). Where the script “videoinput” does not exist, and if the script is made, for example, like the parts enclosed with the broken lines of FIG. 8, the data existing already as a file or the data specified by the URL of the Web is displayed on the display screen (ST111).

After one of the interfaces is selected at Step ST107, the script determination architecture 32 further interprets the character string succeeding the character string indicating an external information source such as “video2” by referring to the schema. That is, in the present embodiment, the script determination architecture 32 determines whether the term “?” exists at a position succeeding the character string indicating an external information source or not (Step ST108). When the term “?” exists, the script determination architecture 32 interprets the character strings succeeding the term “?” by referring to the schema, and determines the content of the control of the equipment connected to the selected interface. Then, the script determination architecture 32 reports a parameter for control to the information control architecture 35 (Step ST109). The information control architecture 35 controls the equipment connected to the selected interface on the basis of the parameter reported from the script determination architecture 32.

As described above, in the television set 100, it is possible to display the media information entered from the external interface such as the network interface 7, the BS tuner 8, the terrestrial broadcast tuner 9, the video input terminal 10, the audio input terminal 11, the memory card slot 12, the i-Link 13 and the like to the display region defined with the layout script text.

Moreover, in the television set 100, it is also possible to select the equipment connected to the video input terminal 10 such as a PC, a DVD, a game machine and the like, and to display the media information taken in from the equipment in the display region defined by the layout script text.

Next, as described above, the mechanism enabling a user to select the layout of each medium in the case where the visual media information from various external information sources is displayed on a display screen at the same time will be described.

As described above, it becomes possible to define the interface of electronic equipment as an external information source with a layout script, and thereby it can be expected that demands of users of displaying respective contents in various layouts according to the defined interfaces become larger.

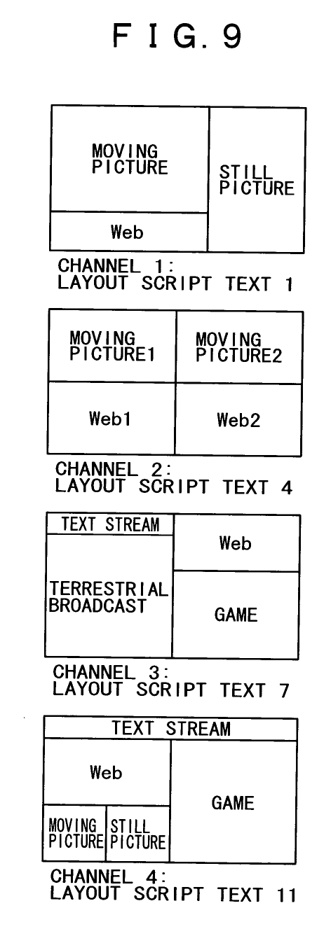

It is possible to satisfy the demands by realizing a mechanism enabling a user to selectively obtain various layout script texts different from each other in their layouts, for example, as shown in FIG. 9.

As a method for opening the layout script texts of such various layouts to users and presenting them to the users, there are a method in which a server for presenting the layout script texts is provided in the Internet and a layout script text selected according to a request from a user is presented to the user through the Internet, a method in which layout script texts having various layouts are recorded in detachably mountable storage media such as a Memory Stick, an SD memory card, a Compact Flash (registered trademark), Smart Media, a MMC and the like and the storage media are distributed to users widely through various methods such as through shops, and the like.

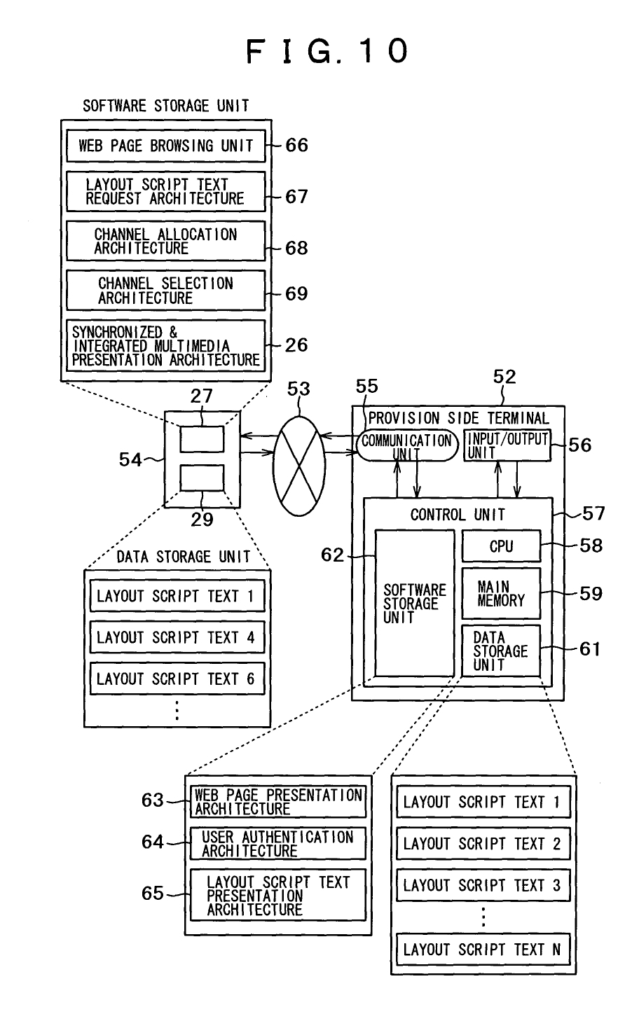

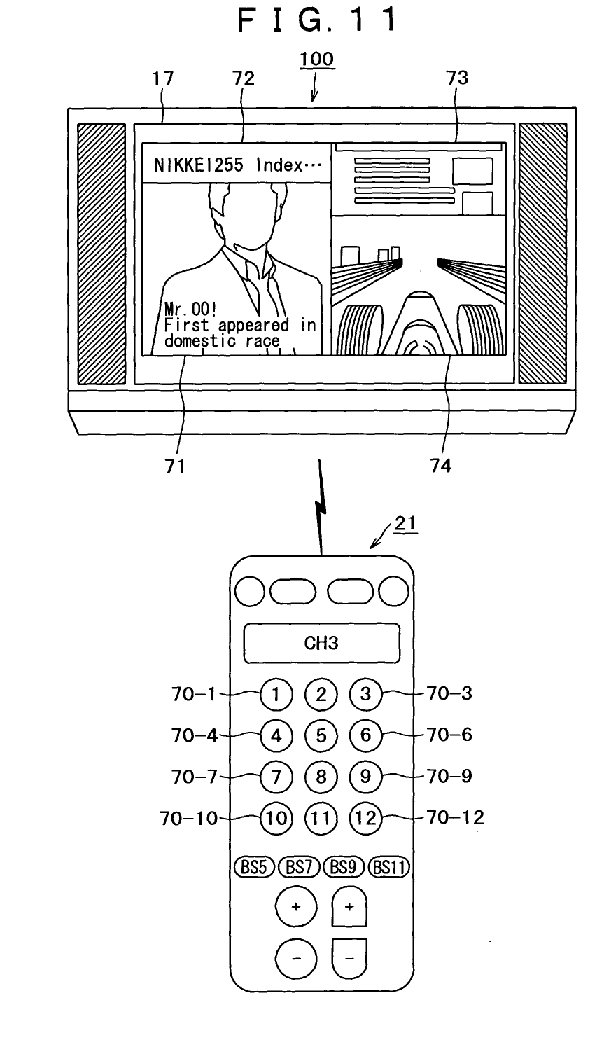

FIG. 10 shows a configuration example of a system for distributing a layout script text from a server to a user (request side equipment) as a client. As shown in FIG. 10, a presentation server (hereinafter, called as a server) 52 of the layout script text is connected to a request side terminal 54 through the Internet 53. Hereupon, the request side terminal 54 is an electronic equipment such as the television set, the PDA, the mobile telephone, the PC and the like described above.

The server 52 is equipped with a communication unit 55 for performing communication through the Internet 53, an input/output unit 56 such as a keyboard, a display, a speaker and the like, and a control unit 57. The control unit 57 is composed of a CPU 58, a main memory 59, a data storage unit 61 for storing various data, and a software storage unit 62 for storing various software.

The data storage unit 61 stores layout script texts of various layouts as shown in FIG. 9.

The software storage unit 62 stores the software for realizing a Web page presentation architecture 63, a user authentication unit 64, a layout script text presentation architecture 65 and the like on the hardware resources of the server 52.

The web page presentation architecture 63 is a program for realizing in the server 52 the function of opening a Web page for presenting a layout script text in the Internet 53.

The user authentication unit 64 is a program for realizing in the server 52 the function of performing the authentication of a user to whom the layout script text is presented.

The layout script text presentation architecture 65 is a program for realizing in the server 52 the function of retrieving a corresponding layout script text from the data storage unit 61 in response to a request from the request side terminal 54, and of transmitting the retrieved layout script text to the request side terminal 54 through the Internet 53.

The configuration of the hardware of the request side terminal 54 is the one shown in FIG. 1 in the case where the request side terminal 54 is a television set. The software storage unit 27 of the request side terminal 54 stores the software for realizing a Web page browsing unit 66, a layout script text request architecture 67, a channel allocation architecture 68, a channel selection architecture 69 on the hardware resources of the request side terminal 54 in addition to the synchronized integrated multimedia presentation architecture 26.

The Web page browsing unit 66 is a program for realizing in the request side terminal 54 the function of accessing a Web page opened to the public on the Internet 53 to browse the Web page.

The layout script text request architecture 67 is a program for realizing in the request side terminal 54 the function of selecting a desired layout script text through the browse of the presentation page of the layout script text by means of the Web page browsing unit 66 to request the presentation of the layout script text to the server 52. The layout script text distributed by the server 52 is stored in the data storage unit 29.

The channel allocation architecture 68 is a program for realizing in the request side terminal 54 the function of allocating the layout script texts stored in the data storage unit 29 to each channel selection button of the remote controller 21 in, for example, the television set 100 shown in FIG. 1 in a one-to-one correspondence by the setting operation of a user.

The channel selection architecture 69 is a program for realizing in the request side terminal 54 the function of setting the layout script text corresponding to the channel selection button of the remote controller 21 to which the selection operation of a user is performed as the layout script text to be used by the integrated multimedia presentation architecture 26.

Next, an example of a procedure of transmitting a layout script text from the server 52 to the request side terminal 54 through the Internet 53 will be described.

The request side terminal 54 accesses the presentation page of the layout script texts opened to the public by the server 52 with the Web page browsing unit 66, and performs the selection and the distribution request of a desired layout script text with the layout script text request architecture 67.

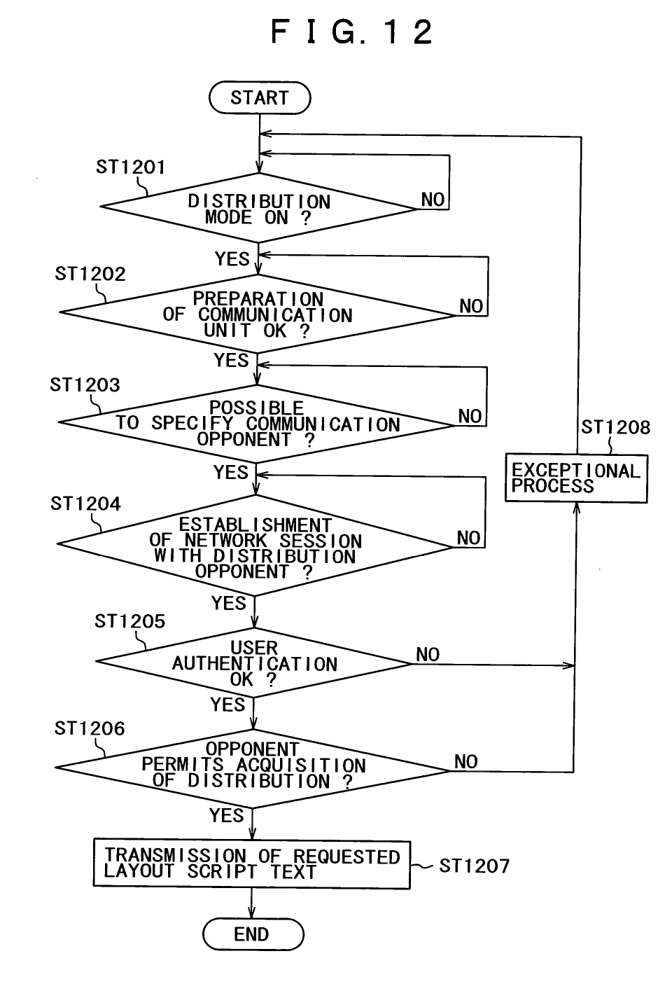

When the layout script text presentation architecture 65 of the server 52 receives the distribution request of the layout script text from the request side terminal 54, the layout script text presentation architecture 65 executes the procedure shown in FIG. 12.

The layout script text presentation architecture 65 ascertains whether a distribution mode is set to be on or not (Step ST1201). When the distribution mode is set to be on, then the layout script text presentation architecture 65 successively ascertains whether the communication of the communication unit 55 is prepared or not (Step ST1202). When the communication is prepared, the layout script text presentation architecture 65 ascertains whether the requester of the layout script text is specified or not (Step ST1203). When the requester of the layout script text can be specified, the layout script text presentation architecture 65 tries the establishment of a network session with the requester (Step ST1204). When the network session can be established, the layout script text presentation architecture 65 performs the user authentication by means of the user authentication unit 64 (Step ST1205). When the user authentication is succeeded, the layout script text presentation architecture 65 examines whether the requester is permitted the reception of the layout script text or not (Step ST1206). But if the user authentication is not succeeded, then the processing returns to Step ST1201 after an exceptional process is executed (Step ST1208). When the requester is permitted the reception of the layout script text, the layout script text presentation architecture 65 transmits the layout script text selected by the requester to the request side terminal 54 through the Internet 53 (Step ST1207), and otherwise, the processing returns to Step ST1201 after the exceptional process is executed (Step ST1208).

When the request side terminal 54 receives the distribution of the layout script text from the server 52, the request side terminal 54 stores the layout script text in the data storage unit 29.

Next, an example of the procedure for selecting a layout of the multimedia display screen to reproduce the selected layout in the request side terminal 54 will be described.

FIG. 11 shows the remote controller 21 and an example of multimedia contents displayed on the display screen 17 of the television set 100 in accordance with the layout script text allocated to a channel selection button mounted on the remote controller 21.

As shown in FIG. 11, the remote controller 21 is provided with a plurality of channel selection buttons 70-1 to 70-12 for, for example, terrestrial wave broadcasts. It is possible for the channel allocation architecture 68 to allocate arbitrary layout script texts to the channel selection buttons 70-1 to 70-12 in a one-to-one correspondence by the operations of a user.

In the present example, when a user pushes the channel selection button 70-3, four media of a terrestrial broadcast 71, a text stream 72, a Web 73 and a game 74 are displayed in the display screen 17 of the television set 100 in accordance with the layout script text 7 allocated to the channel selection button 70-3. The television set 100 is adapted to be able to switch the layout of the multimedia display screen successively by pushing other channel selection buttons of the remote controller 21.

As described above, in the case where the request side terminal 54 is the television set 100 as shown in FIG. 1, it is possible to select or to change the layout of the multimedia screen easily by allocating arbitrary layout script texts to the channel selection buttons 70-1 to 70-12 of the remote controller 21 in the one-to-one correspondence.

Moreover, as a method for selecting a layout script text stored in the request side terminal 54, it may be adopted to display a list of the layouts to be realized by each of the stored layout script text visually for a user's selection of a desired layout in the list.

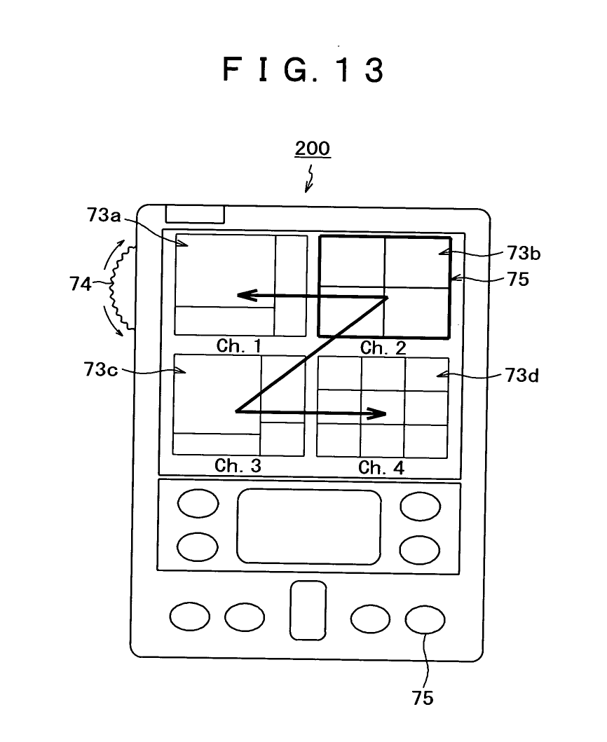

FIG. 13 shows a form realizing the selection of a layout on, for example, a PDA from the list of the layouts realized by each of a plurality of layout script texts in a manner described above.

As shown in FIG. 13, in the example, the layouts 73a, 73b, 73c and 73d of screens realized by each layout script text are visually displayed on the display screen 72 a PDA 200. A user can visually ascertain the screen layouts 73a, 73b, 73c and 73d of all of the layout script texts by, for example, a scroll operation of the screens. When the user selects the desired screen layout among the displayed screen layouts 73a to 73d, for example, the user rotates a jog dial 74 being a rotatable operation unit mounted on a side face of the PDA 200 to shift the position of a focus 75 indicating a selectable object (an individual layout image in this case) visually. Then, the user selects a desired layout image by the use of a decision button 76 or the like in the state of locating the focus on the desired layout image.

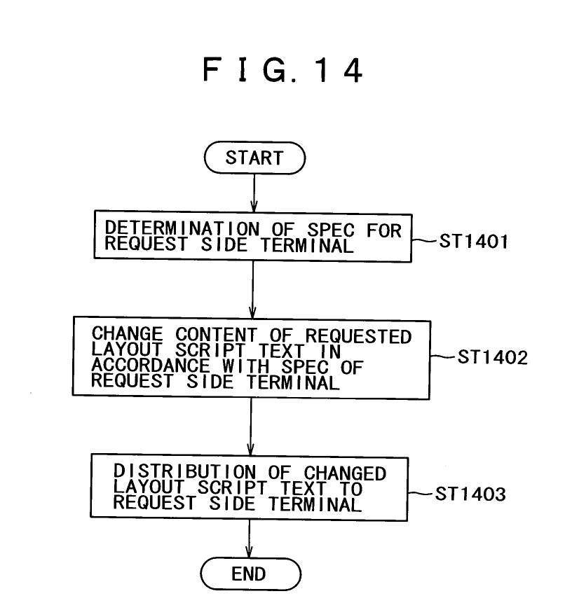

Incidentally, as a service on the server side, as shown in FIG. 14, the following method may be adopted. That is, the specifications, e.g. a screen size, of the request side terminal 54 which requests the distribution of a layout script text, and the kinds of mounted input equipment are automatically determined (Step ST1401); the content of the layout script text is changed in accordance with the specifications of the request side terminal 54 on the basis of the determination results (the change of the size of the display region, and the invalidation of a media input from input equipment which the request side terminal 54 does not include) (Step ST1402); and then the changed layout script text is distributed (Step ST1403).

In this case, as a method of the server side's recognition of the specifications of the request side terminal 54, Composite Capabilities/Preference Profiles (CC/PP) enacted by the W3C and the like exist. Thereby, the request side terminal 54 can acquire the layout script text which has been optimized according to the specifications of the request side terminal 51.

Incidentally, the present invention is not limited to any of the embodiments described above, and the present invention can be implemented by being change within the subject matter of the invention. For example, the visual media to be displayed in the display region defined by the layout script text may be video data already stored as a file and the like.

Moreover, in the embodiment described above, the case where the SMIL is used as the layout script language is described, but the present invention is not limited to such a case. The invention can be applied to the cases where the other layout script languages are used similarly. For example, the invention can be also used in the case the HTML and the TIME which have the functions similar to those of the SMIL as an integrated language.

What is claimed is:

1. An electronic equipment comprising:
a display unit including a display screen;
an interface for inputting visual media information from outside;
script text acquisition means for taking in a media element including said visual media information to be input from said interface and a script text defining at least a display layout of said media element on said display screen from outside;
a script text storage unit for storing one or more script texts taken in by said script text acquisition means;
script text selection means for selecting an arbitrary script text from one or more script texts stored in said script text storage unit; and
script process means for displaying said media element on said display screen in accordance with said script text selected by said script text selection means.

2. The electronic equipment according to claim 1, wherein
said interface includes a function of inputting visual media information different from each other through a plurality of channels, and
said script text includes information for defining said interface for inputting said media element and a channel of said interface.

3. The electronic equipment according to claim 1, wherein
said script text acquisition means selects a desired script text and takes in said script text from a server for presenting said script text through a network.

4. The electronic equipment according to claim 1, wherein
said script text acquisition means selects a desired script text and takes in said script text from a detachably mountable storage medium which records said script text.

5. A server comprising:
a script text storage unit for storing a media element including visual media information to be input into an electronic equipment from outside through an interface, and a script text defining at least a display layout of said media element on a display screen; and
script text distribution means for reading a corresponding script text from said script text storage unit to distribute said script text to said electronic equipment through a network in response to a request from said electronic equipment as a client.

6. The server according to claim 5, further comprising:
recognition means for recognizing a specification of said electronic equipment as a requester; and
script change means for changing a content of a script text read from said script text storage unit to be optimized according to said specification of said electronic equipment recognized by said recognition means.

7. A presentation method of a layout script text, said method comprising the steps of:
connecting a server to an electronic equipment through a network, said server including a media element having visual media information to be input to said electronic equipment from outside through an interface, and a script text storage unit for storing a script text defining at least a display layout of said media element on a display screen, said electronic equipment including a function of making said media element be displayed on the display screen in accordance with an arbitrary script text;
requesting a distribution of said arbitrary script text to said server from said electronic equipment; and
reading a corresponding script text from said script text storage unit to distribute said script text to said electronic equipment through said network in response to said request issued to said server.

8. The presentation method of a layout script text according to claim 7, wherein
said server recognizes a specification of said electronic equipment as a requester,
changes a content of a script text read from said script text storage unit to be optimized in accordance with said recognized specification of said electronic equipment, and
distributes said changed script text to said electronic equipment.
